(19) United States
(12) Patent Application Publication
(10) Pub. No.: US 2025/0144720 A1
(43) Pub. Date: May 8, 2025

(54) Collet Chuck

(71) Applicant: JBS SYSTEM GMBH, Kronshagen (DE)

(72) Inventors: Maik JESS, Kronshagen (DE); Simon AMRHEIN, GroBostheim (DE)

(73) Assignee: JBS SYSTEM GMBH, Kronshagen (DE)

(21) Appl. No.: 18/713,365

(22) PCT Filed: Jan. 30, 2023
(86) PCT No.: PCT/DE2023/100066

§ 371 Date: May 24, 2024

(30) Foreign Application Priority Data
Feb. 10, 2022 (DE) 102022103148.9

(51) Int. Cl. B23B 31/20

(52) U.S. Cl. CPC B23B 31/20; B23B 2231/2075; B23B 2260/104; B23B 2260/128; B23B 2260/144; B23B 2270/32; B23B 2270/38; B23B 2270/48

(57) ABSTRACT

Collet chuck having a plurality of jaws which are radially movable with respect to one another and which, with their clamping faces, form a common receptacle for guiding a rod that is to be machined in a lathe, characterized by a blind hole which is routed in at least one jaw from the outer face, opposite the clamping face of the jaw, in the direction of the clamping face, with a blind-hole bottom which is delimited on the one hand by the clamping face and on the other hand by the blind hole and which, through wear of the clamping face, is configured to effect the formation of a through-hole indicating the wear of the collet chuck.

The invention relates to a collet chuck having a plurality of jaws which are radially movable with respect to one another and which, with their clamping faces, form a common receptacle for guiding a rod that is to be machined in a lathe.

Guide bushes and collet chucks are used to hold and guide the rod of material to be machined by Swiss-type lathes during the machining process and to support it against machining forces. In this way, very long and slim workpieces can be produced with low machining tolerances. Fluctuations in the diameter of the material rod can be compensated for with such guide bushes and rods with different diameters can be machined with the same guide bush.

On Swiss-type lathes, the workpiece is machined by pushing the rod of material through the guide bush with a feed movement of the headstock in the Z direction and the infeed movement of the machining tool in the basic function takes place exclusively in the X direction. The collet chuck is opened and closed pneumatically, whereby opening, closing and feed are usually stored in the machine's production programme.

During material processing, the collet chuck is always closed and exerts a clamping force on the material rod that is required for the respective processing step, particularly during the feed movement.

The feed movement of the material rod in the closed state of the collet chuck generates a frictional force on the inner guide surfaces of the collet chuck, generally referred to below as clamping surfaces, which on the one hand is the result of the clamping force required to guide and hold the material rod during machining and on the other hand is further increased by the cutting pressure of the machining tools. This frictional force leads to frictional wear of the clamping surfaces and thus to a decrease in the precision of holding and guiding, which leads to a loss of quality in machining precision.

This process is gradual, resulting in a reduction in the dimensional accuracy of the workpieces and even exceeding the tolerance. As a rule, this is detected by random checks during production and the collet chuck is replaced.

However, this procedure has the disadvantage that quality losses are recognised too late, workpieces being produced close to the tolerance limit or even rejects are produced, resulting in unplanned downtimes.

Therefore, it is an object of the invention to find a solution for recognising wear of the collet chuck in good time during operation.

According to the invention, this object is solved by the collet chuck with the features of claim 1. The dependent claims describe advantageous embodiments of the invention.

The basic idea of the invention is to equip a known collet chuck with a wear indicator. In particular, the solution according to the invention utilises the fact that the material on the inside of the collet chuck segments, i.e. in the uptake for the material rod, is removed by wear. In particular, abrasive wear leads to the exposure, alteration or destruction of a suitable structure, a marking or a corresponding object located in the inner wall of the collet chuck segments. Depending on the nature of the structure, the marking or the object, the process can be monitored by visual inspection or using physical measurement technology.

One or more, in particular radially extending bores at the front end of the collet jaws are specifically proposed, each of which is designed as a blind bore from the outside inwards to close to the inner wall of the jaws. The remaining dimension between the deepest point of the blind hole and the inner contour of the jaws is specially dimensioned so that it corresponds to the maximum permissible removal due to wear. If material is removed from the inside of the jaws due to wear, an opening is created at the end of the blind hole, turning the blind hole into a through-hole. The inward opening indicates the wear limit and can be easily recognised visually so that the collet in question can be removed from the production process before faulty parts are produced.

The blind holes described can also be monitored remotely, which is particularly preferable. For this purpose, it is preferable to align the blind holes in the jaws with channels in the collet chuck holder, protected against rotation. If compressed air is fed into the blind holes via the channels, a wear-related breakthrough leads to a drop in pressure and triggers a signal.

Furthermore, electrical components such as electromagnetic coils, resistors or RFID chips are proposed as an alternative, which are embedded in the inner wall of the jaws, i.e. the bottom of the blind hole, in such a way that they change their properties or are destroyed when material is removed due to wear. The wear limit of the collet chuck can thus be monitored using the relevant electronic measuring methods of remote monitoring.

According to the invention, therefore, a collet chuck is proposed with a plurality of jaws which can move radially relative to one another and which form with their clamping surfaces a common receptacle for guiding a rod to be machined in a lathe, wherein a blind hole is provided in at least one jaw, guided from the outer surface opposite the clamping surface of the jaw in the direction of the clamping surface, with a blind hole base which is bounded on the one hand by the clamping surface and on the other hand by the blind hole and which is arranged to effect the formation of a through-hole indicating the wear of the collet chuck by wear of the clamping surface. The thickness of the bottom of the blind hole therefore corresponds to the predetermined maximum permissible wear of the clamping surfaces of the jaws, which can be detected visually or by a suitable sensor system due to the creation of a through-hole out of the blind hole by means of abrasion.

The blind hole is preferably arranged radially so that a blind hole base with a precisely defined thickness can easily be produced. Furthermore, if the blind hole is arranged radially, it is possible to set up a sensor system aligned axially with the blind or through hole, which can detect the configuration of the hole as a blind hole or through-hole.

It is also preferable to provide a marking arranged in the bottom of the blind hole which is exposed when a through-hole is formed and indicates the wear of the collet, wherein the marking is particularly preferably designed to be wear-resistant. The marking revealed by wear can be detected visually or optically by means of a suitable device when the guide bush or machine tool designed with the collet chuck is at a standstill.

According to an alternative preferred design, a wear-prone electrical component arranged in the bottom of the blind hole is provided, the loss of function of which indicates the wear of the collet chuck. Such an electrical component is preferably an electromagnetic coil, a resistor or an RFID chip. This requires a device in the guide bush or machine tool comprising the collet chuck that monitors the condition of the electrical component.

Both preferred designs have in common that they are arranged in the bottom of the blind hole, spanning the blind hole. This design ensures that the marking or the electrical component remains in the area of the former blind hole even after the bottom of the blind hole has been worn away and can be detected at this point or its presence can be ruled out.

Furthermore, a guide bush is also proposed for guiding a rod to be machined in a lathe, with a collet chuck designed in accordance with the invention and mounted axially displaceably in a collet chuck holder, in which a device is provided which communicates with the blind hole base of the collet chuck and which, when a through-hole produced by wear of the blind hole base is formed, is designed for outputting an alarm signalling the wear of the collet chuck.

This device is in particular a device that detects the presence of a blind hole base, for example an optical device.

According to a further preferred embodiment, the device can be set up to apply compressed air to the blind hole, to detect the air pressure in the blind hole and, in the event of a drop in air pressure detected due to the formation of a through hole, to output the alarm signalling the wear of the collet chuck.

According to an alternative preferred embodiment, the device is designed for communication with the wear-prone electrical component arranged in the blind hole base, wherein the device is set up to output the alarm signalling the wear of the collet chuck in the event of an interruption in the communication between the device and the electrical component.

The invention is explained in more detail below with reference to a particularly preferably designed embodiment shown in the accompanying drawings, wherein:

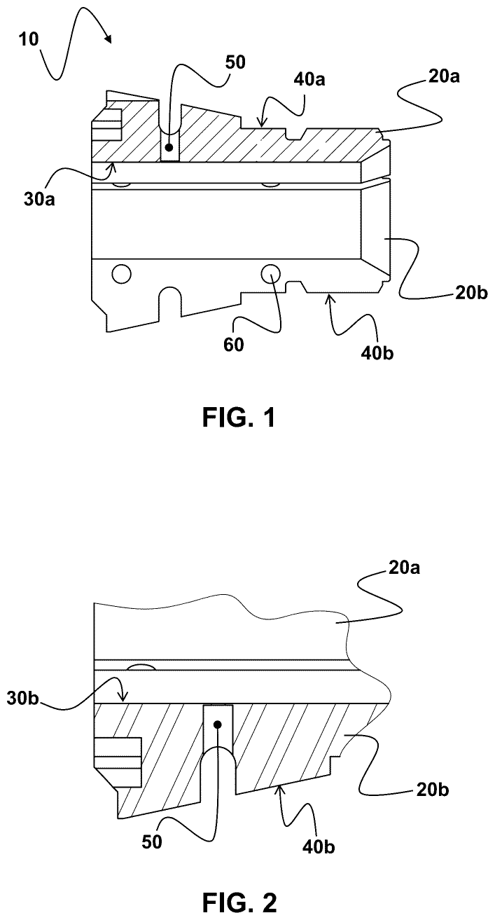

FIG. 1 shows a longitudinal section through a particularly preferably designed collet chuck according to the invention;

FIG. 2 shows a further longitudinal section through the particularly preferably designed collet chuck in a detailed view.

FIG. 1 shows a particularly preferably designed example of a collet chuck according to the invention in a longitudinal section. In the example shown, the collet chuck 10 has three jaws 20a, 20b that can move radially towards each other, of which two jaws 20a, 20b can be seen in the sectional view. The three jaws 20a, 20b form—as is known—with their clamping surfaces 30a, 30b a common holder for guiding a rod to be machined in a lathe. In addition, receptacles 60 provided for fastening spring elements arranged between the jaws 20a, 20b can be recognised in one jaw 20b.

According to the invention, a blind hole 50 extending radially from the outer surface 40a, 40b opposite the clamping surface 30a, 30b of the jaw 20a, 20b in the direction of the clamping surface 30a, 30b is provided in at least one jaw 20a, 20b, wherein the bottom of the blind hole is bounded on the one hand by the clamping surface 30a, 30b and on the other hand by the blind hole 50. The thickness of the bottom of the blind hole corresponds to the predetermined maximum permissible wear-related material removal, which causes the formation of a through-hole indicating the wear of the collet chuck 10.

To indicate wear, a particularly wear-resistant marking can preferably be provided in the bottom of the blind hole, which is exposed when a through-hole is formed and indicates the wear of the collet chuck 10.

Alternatively, an electrical component susceptible to wear can be provided in the bottom of the blind hole, the loss of function of which indicates the wear of the collet chuck. The electrical component is in particular a electromagnetic coil, a resistor or an RFID chip.

It is particularly preferable for the marking or the electrical component to be arranged in the bottom of the blind hole, spanning the blind hole 50, so that it basically remains in the area of the originally formed bottom of the blind hole when the through-hole is formed.

FIG. 2 shows a further longitudinal section through the particularly preferably designed collet chuck in a detailed view, from which it can be seen that the bottom of the blind hole has a small thickness, which corresponds to the maximum permissible wear for the use of the collet chuck 10. If the bottom of the blind hole is completely removed due to wear of the clamping surfaces 30a, 30b, this wear can be recognised by detecting a through-hole instead of a blind hole and the collet chuck 10 can be replaced.

1. A guide bush with a collet chuck, which is mounted axially displaceably in a collet chuck holder, having a plurality of jaws which are radially movable with respect to one another and which, with their clamping faces, form a common receptacle for guiding a rod that is to be machined in a lathe, comprising:
a blind hole which is routed in at least one jaw from the outer face, opposite the clamping face of the jaw, in the direction of the clamping face, with a blind-hole bottom which is delimited on the one hand by the clamping face and on the other hand by the blind hole and which, through wear of the clamping face, is configured to effect the formation of a through-hole indicating the wear of the collet chuck and
a device communicating with the bottom of the blind hole of the collet chuck, the device being designed to output an alarm signaling the wear of the collet chuck when a through-hole is formed due to wear of the bottom of the blind hole, wherein the device is designed for applying compressed air to the blind hole, for detecting the air pressure in the blind hole and, in the event of a drop in air pressure detected due to the formation of the through-hole, for outputting the alarm signalling the wear of the collet chuck.

2. The collet chuck according to claim 1, further comprising a marking arranged in the bottom of the blind hole and indicating the wear of the collet chuck when a through-hole is formed.

3. The collet chuck according to claim 2, wherein the marking is wear-resistant.

4. The collet chuck according to claim 1, further comprising a wear-prone electrical component arranged in the bottom of the blind hole, the loss of function of which indicates the wear of the collet chuck.

5. The collet chuck according to claim 4, wherein the electrical component is an electromagnetic coil, a resistor or an RFID chip.

6. The collet chuck according to claim 2, wherein the marking or the electrical component is arranged in the bottom of the blind hole, spanning the blind hole.

7. The collet chuck according to claim 1, wherein the blind hole is arranged radially.

8. (canceled)

9. (canceled)

10. The guide bush according to claim 1, wherein the device is designed for communication with the wear-prone electrical component arranged in the bottom of the blind hole, the device being designed for outputting the alarm signaling the wear of the collet chuck in the event of an interruption in communication between the device and the electrical component.
